(19) United States
(12) Patent Application Publication
(10) Pub. No.: US 2004/0083153 A1
(43) Pub. Date: Apr. 29, 2004

(54) Method and system for evaluating internal business investments by estimating decision-factor variations

(76) Inventors: John Larsen, Odenton, MD (US); Justin Parke, Washington, DC (US)

Correspondence Address: WEISS & MOY PC, 4204 NORTH BROWN AVENUE, SCOTTSDALE, AZ, 85251, US

(21) Appl. No.: 10/635,068

(22) Filed: Aug. 6, 2003

Related U.S. Application Data
(63) Continuation-in-part of application No. 10/281,477, filed on Oct. 24, 2002.

(51) Int. Cl. G06F 17/60

(52) U.S. Cl. 705/36

(57) ABSTRACT

A method and system for evaluating internal business investments by estimating decision-factor variations provides a powerful decision-making tool for deciding whether or not to invest in a particular internal business option or for selecting between business investment alternatives. The investment may be a capital investment, a program investment, personnel investment or other business strategy. Variations in cost, benefit, strategic alignment and risk values input to the business decision tool are used to adjust the business value of a business case. The variations can be estimated from data gathered from surveys of personnel rating a confidence or perceived variation from the input values, variations may be estimated in the computed business value due to interdependencies to other adopted or non-adopted business cases, or variations may be estimated based on actual historical collected data on business case performance. Statistical analysis, including real options analysis and/or efficient portfolio analysis can be used to provide a visual or other tool to a system user in order to evaluate multiple business cases.

### CROSS-REFERENCE TO RELATED APPLICATIONS

This application is a continuation-in-part of U.S. patent application Ser. No. 10/281,477, entitled “BUSINESS CASE SYSTEM”, filed Oct. 24, 2002, the specification of which is incorporated herein by reference.

### BACKGROUND OF THE INVENTION

1. Field of the Invention

The present invention relates generally to business decision-making systems and software, and more specifically, to a method and system for evaluating internal business investments.

2. Background of the Invention

The above-incorporated parent application “BUSINESS CASE SYSTEM” provides a decision making tool that evaluates internal business investments in a sophisticated multi-factored analysis that includes cost, benefit, risk, strategic impact over multiple functional areas within an organization. The methods disclosed therein are generally provided on a networked computer system providing access for multiple department input to a business case decision process, which is a process of evaluation of a prospective internal business investment based on the above factors.

The system and methodology described in the above-incorporated parent application provides sophisticated decision-making support that considers the impact of adoption or denial of a business case over multiple departments/functional areas and also the impact of delays on particular cases. By supporting the decision-making process with detailed cross-related impacts on the strategic goals of an organization, budgeting can be more effectively managed at a greater level of detail. Rather than cutting particular cases due to cost ranking or cutting funds at fixed percentages, critical cases can be identified and funded, while non-critical cases can be evaluated either in rank of criticality or based on other factors such as risk levels.

However, several needs have been identified for investment evaluation that extend the scope of existing business decision tools. Present tools do not include management of a degree of variation of the above factors, such as volatility of risk, confidence in the factors input to the decision-making process. Typically such factor variations are weighed in business decisions made by individuals or groups and are not part of automated decision-making processes. Further, when prompting user input for such figures, it would be desirable to provide more accurate results by reducing a tendency to input personally standardized values (i.e., a particular user fills in a fixed risk value for all investments) or to weigh more heavily certain investments based on non-analytical rationales.

Finally, business case decision-making tools typically manage individual cases or alternative cases and do not effectively manage changes in one case that may affect other cases, including tracking variations in factors in a case.

Therefore, it would be desirable to provide an improved method and system for evaluating internal business investments that takes into account variation and confidence in case evaluation factors, provides an improved mechanism for obtaining such information and manages the interdependencies of investments.

### SUMMARY OF THE INVENTION

The above objective of providing an improved internal business investment evaluation is accomplished in a method and system for business decision-making. The method may also be embodied in a computer program product and system containing computer-readable program instructions for carrying out the steps of the method on a general-purpose or workstation computer system.

The method and system generate and evaluate business cases using input factors including cost, benefit, risk, strategic alignment and business priorities. The input factors may also include intangibles such as value to provide management information or competitive advantage. Variations in one or more of the above factors are used to adjust the evaluation result of the business case. The variations include one or more of: an adjustment based on collection of confidence or variation ranges confirmed by multiple individual user input; an adjustment based on questionnaire data from individual or multiple individual user input that estimate variations in the business case factors; an adjustment based on actual business case performance; and/or an adjustment based on interrelationships between investments and/or investment performance.

As such, the present invention provides a powerful and novel software tool for automating decision-making processes surrounding on-going or initial business investment decisions, such as information technology purchases or development, project investment decisions/business area entry decisions, as well as internal overhead investments, management investments, employee-centered investments and customer-centered investments.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which the present invention may be practiced.

FIG. 2 is a pictorial diagram depicting a user interface of a computer program in accordance with an embodiment of the present invention.

FIG. 3 is a pictorial diagram depicting a flow of information between functional blocks within a computer program in accordance with an embodiment of the present invention.

FIG. 4 is a flowchart depicting operation of a system executing a method in accordance with an embodiment of the present invention.

### DETAILED DESCRIPTION OF THE EMBODIMENTS

The above-incorporated parent application describes an organizational software tool for making business decisions regarding adoption/non-adoption of one or more “business cases”. Business cases are decision models for justifying corporate or business investments based on input that includes cost, expected financial benefit, strategic alignment and risks. The input factors may also include intangibles such as value to provide management information or competitive advantage. The software tool provides automated management and analysis of business cases as a tool to aid management selection, technical selection (including information technology—IT selection), and budgeting or financial selection of one or more business cases. The present invention concerns improvements to the previously-disclosed business case management system that provide models for variations in the business case parameters, as well as other desirable features described herein below. The variations may include confidence and volatility checks (as well as mean value deviation checks) produced by survey weighted answer data generated by surveys provided to review panels. The variations may include historical checks for in-progress business cases, for adjusting the business value of an adopted business case as the case progresses. The variations also may include adjustments in business case parameters due to adoption/non-adoption of other business cases.

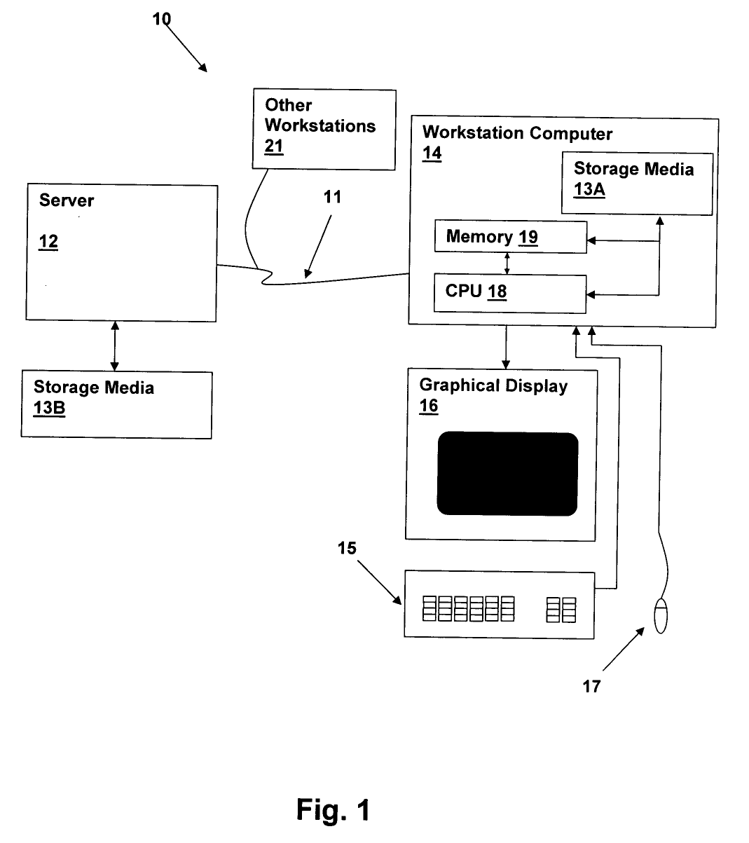

Referring now to the figures and in particular to FIG. 1, there is depicted a computer system 10 within which a method may be performed via the execution of program instructions forming a computer program product and computer system in accordance with an embodiment of the present invention. The method may employ program instructions located within a memory 19 of a workstation computer 14 and executed by a central processing unit 18 (CPU) and the program instructions of embodiments of the present invention may be located entirely within a storage media 13A and memory 19. Alternatively, workstation computer 14 may be coupled via a network 11 connection for coupling workstation computer 14 to a network such as a local-area network (LAN), wide-area network (WAN) or the Internet. In a network implementation, the data store and/or program instructions for implementing the methods of the present invention may be located within a server 12 coupled to a storage media 13B. Workstation 14 is shown configured as attached to a graphical display 16 on which program and/or browser output is displayed to a user and coupled to input devices such as a mouse 17 and a keyboard 15 for receiving user input. Other workstations 21 are also shown coupled to network connection 11 providing a multi-user networked computer system. Network connection 11 may be any form of network for exchanging data, including ATM networks, LANs, wireless LANs or other suitable data exchange network. Additionally, portable devices such as personal digital assistants (PDAs) and other hand-held or portable devices can be provided with a user interface and wired or wireless to the system so that the computer program of the present invention may be used in locations removed from workstations 14. Security is provided in the system through password access, encryption and other devices known in the art for protecting proprietary network communications, data and authenticating authorized-user access.

In general, as the present invention provides a tool that links multiple departments, possibly multiple organizations and therefore multiple users, an Intranet implementation executing on server 12 and generating output to a browser program executing within workstation computer 14 will be described, although it should be understood that the principles embodied herein are not limited as to implementation of an actual computing system, other than generally it is preferred to have multiple workstations 21 assigned to multiple users that provide the checks and balances inherent in some portions of the methods embodying the present invention.

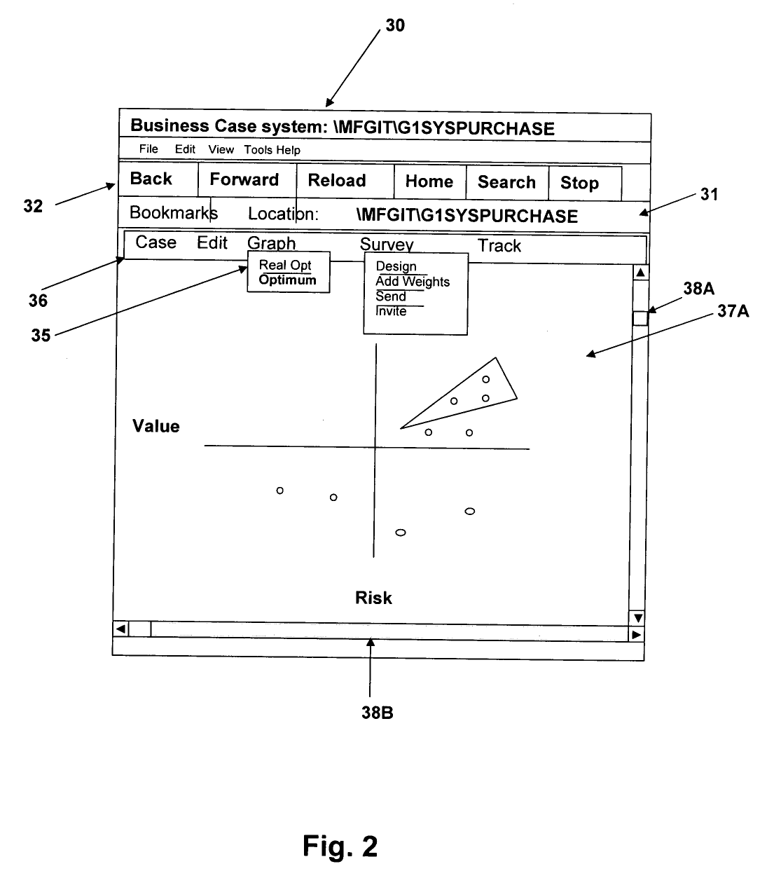

Referring now to FIG. 2, a user interface provided as a graphical output on graphical display 16 is depicted as a network browser window 30. As mentioned above, while a network browser interface provides a portable and easily-remoted portal to a system, a user interface in accordance with alternative embodiments of the invention may be provided by a proprietary program. Browser window 32 includes standard browser controls such as sliders 38B and 38A, a browser location bar 31 and a browser content window 37A. The content window as depicted includes a program menu 36 for selecting options within the program of the present invention. Program menu 36 items may include drop-down or pop-up menus for selecting items in further tiers of the menu hierarchy. Illustrated are drop-down menus associated with tow items, graph and survey for illustrating features of the present invention. However, in general more than one pull-down will not be active at the same tier level.

The graph option shows selections of “Real Options” display or “Optimum Portfolio” graph display as two of many data views that may be provided. Real Options is a feature that is known in the financial world for evaluating individual investments based on a statistical analysis and provides a mechanism for selecting particular investments. The present invention employs Real Options as one of multiple ways of looking at business case value. The Optimum Portfolio is another data view that is depicted within browser content window 37A. Optimum Portfolio analysis is another known financial tool for selecting groupings of investments for optimum return.

The Survey menu option is used to set up and implement surveys that assist in determining variation in business case parameters, particularly by providing a “sanity check” mechanism that uses questions posed to organizational members other than the business case originator(s). Answers to the survey questions are given numerical weights that correspond to one or more of the cost, financial benefit, risk, intangibles and strategic alignment parameters used to compute a business case value. The survey options include design survey (add/delete/change questions and answers), add weights (map the answers to the business case parameter values). Options “send” and “invite” are provided for initiating survey interaction from other users. Surveys provide a mechanism for overcoming barriers to evaluating business cases and for gathering efficiently useful data from a potentially large number of reviewers or over a large number of business cases. Surveys also permit the measurement of volatility (degree of concurrence between reviewers on one or more business case parameters) and confidence (degree to which reviewers agree with set business case parameters), so that statistical/graphical analysis can inform management decisions.

A “Case” option on menu bar 36 provides for setup of a business case as described in the above-incorporated parent application. Input values are received (or retrieved) for the business case parameters, narrative information can be added, alternative contingencies/risk reduction policies are identified and other information that can convey to another user the entirety of the business case, as well as the above-mentioned parameters used in the mathematical models. An “Edit option provides a mechanism for altering business cases that have already been entered, which may include further security restrictions as to users permitted to change a business case. A “Track” option is provided for adjusting business case values for in-progress adopted business cases, so that variations in business case parameters can be determined and computed business case value updated as the implementation plan proceeds and for viewing changes in the business case value and parameters.

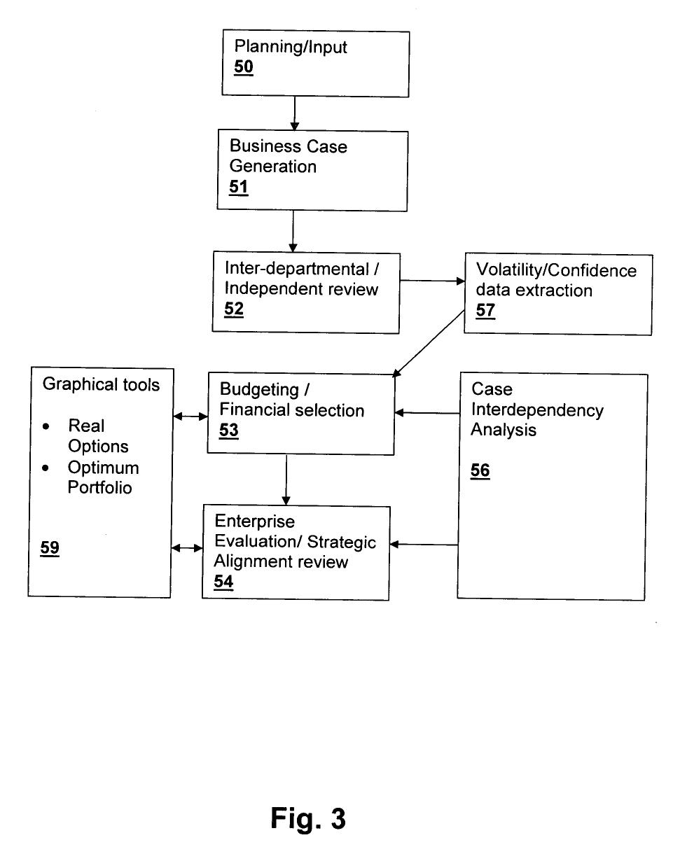

Referring now to FIG. 3, a flow of information between computer program modules accordance with an embodiment of the present invention is shown. A planning/input module 50 receives input of business case parameters including cost, expected financial benefit, risk and strategic alignment, in addition to the above-mentioned narrative and risk management information. A business case generation module 51 generates the business case files and registers the business case for inter-relational factor checking with respect to other business cases (e.g., an adoption of this business case reduces costs of other business cases).

An interdepartmental/independent review module 52 provides survey functionality for determining confidence in the business case parameters or variances of the business case parameters based on surveys provided to other departments, independent review staffs, outside review agencies, or other suitable reviewing groups and variance/confidence data extraction module 57 determines volatility, mean answer deviations and/or confidence levels for the business case parameters from the original entered or current values. The updated and/or statistically distributed and displayed results are provided to a budgeting/financial selection module used by users determining budgetary allocations or evaluating spending on the particular business case(s) being evaluated. Budgeting/financial selection module 53 receives input from case interdependency analysis 56, which may raise or lower costs based on other business case adoption or prospective adoption. Graphical tools module 59 include the aforementioned Real Options display, Optimum Portfolio display, as well as standard and statistical displays of multiple business case data so that financial decisions can be informed with visual tools. Non-graphical displays may include listing business cases by priority, which can be determined by business process, strategic alignment, financial value or intangible value. The graphical tools can also be displayed with one of the above figures of merit as the “value” of the business case, rather than the typical financial merit only display of the financial analysis-type software packages.

Enterprise evaluation/strategic alignment review module 54 provides for a check on whether or not prospectively adopted business cases meet the strategic goals of the organization and receive input from case interdependency analysis module 56 also, so that strategic impact of combinations of business cases (or non-asserted combinations due to deselection of one or more interrelated business cases) can be adjusted for display to the users via graphical tools 59. While FIG. 3 implies an order of flow, the example is only illustrative of one combination of modules contemplated by the present invention and other arrangements of the modules are possible, such as performing strategic alignment review prior to financial selection.

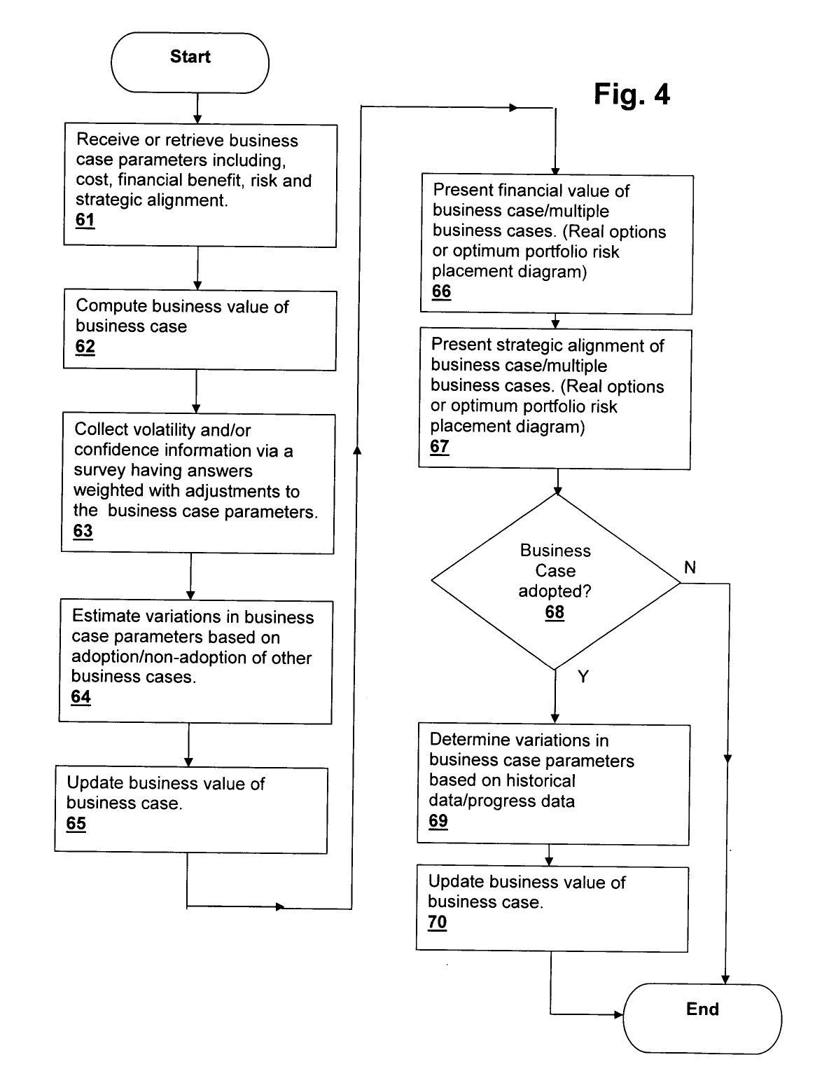

Referring now to FIG. 4, a flowchart depicting a program flow or methodology of the present invention is depicted. First, business case parameters including cost, financial benefit, risk, intangibles and strategic alignment are received as input or retrieved from storage (step 61). Next, a prospective business value of the business case is generated (step 62). Then, variance and/or confidence information is obtained via a survey having weighted answers that imply adjustments to the business case parameters (step 63). Then, the business case parameter variations are estimated based on adoption or non-adoption of other business cases (step 64) and the business case value is updated (step 65) in conformity with one or more of the variations determined in steps 63 and 64.

Once a business value is computed, the case financial value is presented (step 66), generally along with other case values in a graphical display. The strategic alignment is also displayed in (step 67), which may or may not be contingent on a funding commitment. If the business case is adopted, i.e. the case met financial and strategic alignment requirements or was funded for another reason (decision 68), variations in the business case parameters are tracked over time (step 69) and the current business value updated and tracked (step 70).

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for determining a business value of a business case to an organization, comprising:
receiving input of cost information to implement said business case;
second receiving input of financial benefit information estimating a financial benefit afforded by adoption of said business case;
third receiving input of risk information estimating a risk associated with adoption of said business plan;
fourth receiving input of strategic impact of adoption of said business plan on one or more strategic goals of said organization;
fifth receiving input of intangible impact of adoption of said business plan;
computing said business value in conformity with said cost information, financial benefit information, risk information, intangible impact and strategic impact information;
gathering data for estimating a variation of actual values corresponding to one or more of said cost information, financial benefit information, risk information and strategic impact information; and
updating said computed business value in conformity with said gathered data.

2. The method of claim 1, wherein said gathering gathers confidence parameters reflecting confidence in one or more of said cost information, financial benefit information, risk information, intangible impact and strategic impact information, in response to user input from users providing objective evaluation of said actual values against said input cost information, financial benefit information, risk information and strategic impact information.

3. The method of claim 1, wherein said gathering gathers volatility parameters reflecting a volatility of one or more of said cost information, financial benefit information, risk information, intangible impact and strategic impact information, and further comprising performing a statistical analysis on said computed business value in conformity with said volatility parameters, whereby said business value is adjusted for evaluation against other business cases.

4. The method of claim 3, wherein said statistical analysis comprises a real options analysis.

5. The method of claim 1, wherein said gathering gathers interdependency parameters reflecting a variation of one or more of said cost information, financial benefit information, risk information, intangible impact and strategic impact information, as a function of adoption of one or more other business cases.

6. The method of claim 1, wherein said gathering gathers historical data reflecting a variation of one or more of said cost information, financial benefit information, risk information, intangible impact and strategic impact information after adoption of said business cases, whereby said business case is evaluated on an on-going basis.

7. The method of claim 1, further comprising:
repeating said steps of first receiving, second receiving, third receiving, fourth receiving, fifth receiving and computing for each of a plurality of business cases;
receiving sixth input of a fixed acceptable risk value; and
selecting an efficient portfolio maximizing a total of said financial benefit information from a total of said cost information.

8. The method of claim 1, wherein said gathering comprises:
providing a series of questions relating to one or more of said cost information, financial benefit information, risk information, intangible impact and strategic impact information, wherein each of said questions has an answer selectable from a list of answers, and wherein each of said answers has an associated weighted value for adjusting an associated one of said cost information, financial benefit information, risk information, intangible impact and strategic impact information; and
collecting said weighted values selected in response to said series of questions, whereby said variation is estimated in conformity with said collected weighted values.

9. The method of claim 8, further comprising:
issuing said series of questions to a plurality of system users, and wherein said collecting collects said weighted values from responses of said plurality of system users; and
averaging said weighted values for each of a plurality of sets of questions, each set of questions relating to one of said cost information, financial benefit information, risk information, intangible impact and strategic impact information, and wherein said updating updates each of said cost information, financial benefit information, risk information, intangible impact and strategic impact information in conformity with results of said averaging.

10. The method of claim 1, further comprising:
repeating said steps of first receiving, second receiving, third receiving, fourth receiving, fifth receiving and computing for each of a plurality of business cases; and
generating a graphical depiction of placement of said computed business values versus risk, whereby a system user can view the relative merits of said plurality of business cases.

11. A computer system comprising a processor for executing program instructions and a memory coupled to said processor for storing program instructions and data, wherein said program instructions comprise program instructions for:
receiving input of cost information to implement said business case;
second receiving input of financial benefit information estimating a financial benefit afforded by adoption of said business case;
third receiving input of risk information estimating a risk associated with adoption of said business plan;
fourth receiving input of strategic impact of adoption of said business plan on one or more strategic goals of said organization;
fifth receiving input of intangible impact of adoption of said business plan;
computing said business value in conformity with said cost information, financial benefit information, risk information and strategic impact information;
gathering data for estimating a variation of actual values corresponding to one or more of said cost information, financial benefit information, risk information and strategic impact information; and
updating said computed business value in conformity with said gathered data.

12. The computer system of claim 11, wherein said program instructions for gathering gather confidence parameters reflecting confidence in one or more of said cost information, financial benefit information, risk information, intangible impact and strategic impact information, in response to user input from users providing objective evaluation of said actual values against said input cost information, financial benefit information, risk information and strategic impact information.

13. The computer system of claim 11, wherein said program instructions for gathering gather volatility parameters reflecting a volatility of one or more of said cost information, financial benefit information, risk information, intangible impact and strategic impact information, and further comprising program instructions for performing a statistical analysis on said computed business value in conformity with said volatility parameters, whereby said business value is adjusted for evaluation against other business cases.

14. The computer system of claim 13, wherein said program instructions for performing said statistical analysis comprise program instructions for performing a real options analysis.

15. The computer system of claim 11, wherein said program instructions for gathering gather interdependency parameters reflecting a variation of one or more of said cost information, financial benefit information, risk information, intangible impact and strategic impact information, as a function of adoption of one or more other business cases.

16. The computer system of claim 11, wherein said program instructions for gathering gather historical data reflecting a variation of one or more of said cost information, financial benefit information, risk information, intangible impact and strategic impact information after adoption of said business cases, whereby said business case is evaluated on an on-going basis.

17. The computer system of claim 11, further comprising program instructions for:
repeatedly executing said program instructions for first receiving, second receiving, third receiving, fourth receiving, fifth receiving and computing for each of a plurality of business cases;
receiving sixth input of a fixed acceptable risk value; and
selecting an efficient portfolio maximizing a total of said financial benefit information from a total of said cost information.

18. The computer system of claim 11, wherein said program instructions for gathering comprise program instructions for:
providing a series of questions relating to one or more of said cost information, financial benefit information, risk information, intangible impact and strategic impact information, wherein each of said questions has an answer selectable from a list of answers, and wherein each of said answers has an associated weighted value for adjusting an associated one of said cost information, financial benefit information, risk information, intangible impact and strategic impact information; and
collecting said weighted values selected in response to said series of questions, whereby said program instructions for updating estimate said variation in conformity with said collected weighted values.

19. The computer system of claim 18, wherein said program instructions further comprise program instructions for:
issuing said series of questions to a plurality of system users, and wherein said program instructions for collecting collect said weighted values from responses of said plurality of system users; and
averaging said weighted values for each of a plurality of sets of questions, each set of questions relating to one of said cost information, financial benefit information, risk information, intangible impact and strategic impact information, and wherein said program instructions for updating update each of said cost information, financial benefit information, risk information, intangible impact and strategic impact information in conformity with results of said averaging.

20. The computer system of claim 11, wherein said program instructions further comprise program instructions for:
repeatedly executing said program instructions for first receiving, second receiving, third receiving, fourth receiving, fifth receiving and computing for each of a plurality of business cases; and
generating a graphical depiction of placement of said computed business values versus risk, whereby a system user can view the relative merits of said plurality of business cases.

21. A computer program product comprising a signal-bearing media encoding program instructions for execution within a general-purpose computer system, wherein said program instructions comprise program instructions for:
receiving input of cost information to implement said business case;
second receiving input of financial benefit information estimating a financial benefit afforded by adoption of said business case;
third receiving input of risk information estimating a risk associated with adoption of said business plan;
fourth receiving input of strategic impact of adoption of said business plan on one or more strategic goals of said organization;
fifth receiving input of intangible impact of adoption of said business plan;
computing said business value in conformity with said cost information, financial benefit information, risk information and strategic impact information;
gathering data for estimating a variation of actual values corresponding to one or more of said cost information, financial benefit information, risk information and strategic impact information; and
updating said computed business value in conformity with said gathered data.

22. The computer program product of claim 21, wherein said program instructions for gathering gather confidence parameters reflecting confidence in one or more of said cost information, financial benefit information, risk information, intangible impact and strategic impact information, in response to user input from users providing objective evaluation of said actual values against said input cost information, financial benefit information, risk information and strategic impact information.

23. The computer program product of claim 21, wherein said program instructions for gathering gather volatility parameters reflecting a volatility of one or more of said cost information, financial benefit information, risk information, intangible impact and strategic impact information, and further comprising program instructions for performing a statistical analysis on said computed business value in conformity with said volatility parameters, whereby said business value is adjusted for evaluation against other business cases.

24. The computer program product system of claim 23, wherein said program instructions for performing said statistical analysis comprise program instructions for performing a real options analysis.

25. The computer program product of claim 21, wherein said program instructions for gathering gather interdependency parameters reflecting a variation of one or more of said cost information, financial benefit information, risk information, intangible impact and strategic impact information, as a function of adoption of one or more other business cases.

26. The computer program product of claim 21, wherein said program instructions for gathering gather historical data reflecting a variation of one or more of said cost information, financial benefit information, risk information, intangible impact and strategic impact information after adoption of said business cases, whereby said business case is evaluated on an on-going basis.

27. The computer program product of claim 21, further comprising program instructions for:
repeatedly executing said program instructions for first receiving, second receiving, third receiving, fourth receiving, fifth receiving and computing for each of a plurality of business cases;
receiving sixth input of a fixed acceptable risk value; and
selecting an efficient portfolio maximizing a total of said financial benefit information from a total of said cost information.

28. The computer program product of claim 21, wherein said program instructions for gathering comprise program instructions for:
providing a series of questions relating to one or more of said cost information, financial benefit information, risk information, intangible impact and strategic impact information, wherein each of said questions has an answer selectable from a list of answers, and wherein each of said answers has an associated weighted value for adjusting an associated one of said cost information, financial benefit information, risk information, intangible impact and strategic impact information; and
collecting said weighted values selected in response to said series of questions, whereby said program instructions for updating estimate said variation in conformity with said collected weighted values.

29. The computer program product of claim 28, wherein said program instructions further comprise program instructions for:
issuing said series of questions to a plurality of system users, and wherein said program instructions for collecting collect said weighted values from responses of said plurality of system users; and
averaging said weighted values for each of a plurality of sets of questions, each set of questions relating to one of said cost information, financial benefit information, risk information, intangible impact and strategic impact information, and wherein said program instructions for updating update each of said cost information, financial benefit information, risk information, intangible impact and strategic impact information in conformity with results of said averaging.

30. The computer program product of claim 21, wherein said program instructions further comprise program instructions for:
repeatedly executing said program instructions for first receiving, second receiving, third receiving, fourth receiving, fifth receiving and computing for each of a plurality of business cases; and
generating a graphical depiction of placement of said computed business values versus risk, whereby a system user can view the relative merits of said plurality of business cases.
